(19) United States
(12) Patent Application Publication
(10) Pub. No.: US 2018/0018295 A1
(43) Pub. Date: Jan. 18, 2018

(54) METHOD FOR AUTOMATICALLY EXCHANGING DEVICE-TO-HOST INTERFACE DIRECTION FOR USB TYPE-C CONNECTIONS

(71) Applicants: Johnny Chen, Taipei City (TW); Chih-Hsiung Chang, Taipei City (TW); Tsung-Min Chen, Taipei City (TW)

(72) Inventors: Johnny Chen, Taipei City (TW); Chih-Hsiung Chang, Taipei City (TW); Tsung-Min Chen, Taipei City (TW)

(73) Assignee: I/O INTERCONNECT, LTD., Santa Ana, CA (US)

(21) Appl. No.: 15/213,347

(22) Filed: Jul. 18, 2016

(51) Int. Cl. G06F 13/42; G06F 13/40; G06F 13/38

(52) U.S. Cl. CPC G06F 13/4282; G06F 13/385; G06F 13/4022

(57) ABSTRACT

The invention is used for a dock between a battery-operated device and a power adapter. The method includes: a) providing a USB dock with a first USB type-C connector and a second USB type-C connector, wherein the two USB type-C connectors are electrically connected through a switch module; b) connecting a first USB device to the first USB type-C connector; c) verifying whether the first USB device sends out a USB host command or not; d) setting the first USB type-C connector and the second USB type-C connector to serve as a host port and a device port, respectively, if yes in step c); and e) setting the first USB type-C connector and the second USB type-C connector to serve as a device port and a host port, respectively, if no in step c).

### BACKGROUND OF THE INVENTION

### 1. Technical Field

The invention relates to connections using USB type-C, particularly to automatic detection to a host and device.

### 2. Related Art

The USB (universal serial bus) Type-C connectors connect to both hosts and devices, replacing various Type-B and Type-A connectors and cables with a standard meant to be future-proof.

A USB interface device, such as a dock, may be provided with two USB Type-C connectors for connecting a host device and an accessory device. For example, the host device may be a battery-operated device such as a laptop computer or a smartphone, and the accessory device may be a power adapter, so that the battery-operated device can be charged by the power adapter through the dock.

Usually, such a USB interface device must designate one of the USB Type-C connectors to be connected with a battery-operated device and the other USB Type-C connector to be connected with a power adapter. However, there must be some users who carelessly connect the device and adapter in an opposite manner. Under this situation, conventional USB interface device cannot work until the device and adapter have been connected correctly. In other words, the device-to-host interface direction in the USB interface device is unchangeable. It will be helpful for users if the USB interface device can automatically exchange its device-to-host interface direction.

### SUMMARY OF THE INVENTION

An object of the invention is to provide a method for automatically exchanging device-to-host interface direction for USB Type-C connections, which can automatically detect which connector the host (battery-operated device) is connected to and change the device-to-host interface direction if necessary.

To accomplish the above object, the invention provides a method for automatically exchanging device-to-host interface direction for USB Type-C connections, including the steps of:

a) providing a USB interface device with a first USB type-C connector and a second USB type-C connector, wherein the two USB type-C connectors are electrically connected through a switch module;

b) connecting a first USB device to the first USB type-C connector;

c) verifying whether the first USB device sends out a USB host command or not;

d) setting the first USB type-C connector and the second USB type-C connector to serve as a host port and a device port, respectively, if yes in step c); and

e) setting the first USB type-C connector and the second USB type-C connector to serve as a device port and a host port, respectively, if no in step c)

### BRIEF DESCRIPTION OF THE DRAWINGS

FIG. 1 is a block diagram of the hardware arrangement of the invention; and

FIG. 2 is a flowchart of the method of the invention.

### DETAILED DESCRIPTION OF THE INVENTION

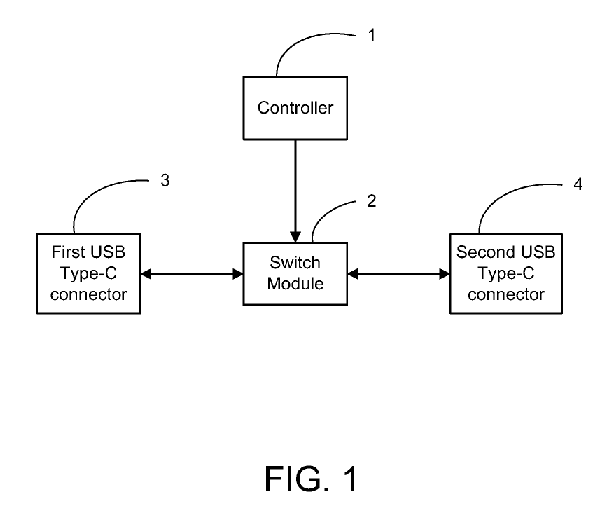

Please refer to FIG. 1. The hardware device of the invention is a USB interface device, such as a dock. The USB interface device includes a controller 1, a switch module 2, a first USB Type-C connector 3 and a second USB type-C connector 4. The controller 1 is electrically connected to the switch module 2 so that the switch module 2 can be controlled by the controller 1. The switch module 2 is electrically connected between the two USB Type-C connectors 3, 4. The two USB Type-C connectors 3, 4 are used for connecting a host device such as a laptop computer or smartphone (not shown) and an accessory device such as a power adapter (not shown). The switch module 2 can form a device-to-host interface channel between the two USB Type-C connectors 3, 4.

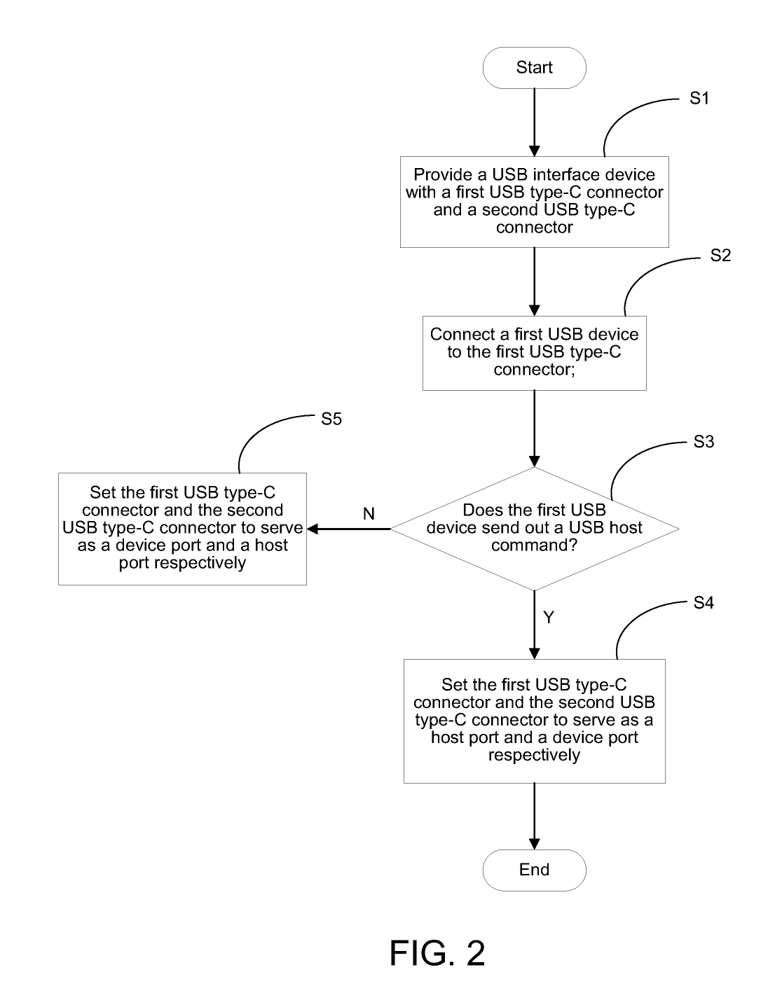

Please refer FIG. 2, which shows a flowchart of the method of the invention. In step S1, a USB interface device is provided. As above-mentioned, the USB interface device may be a dock with a first USB Type-C connector 3 and a second USB Type-C connector 4. In step S2, a first USB device is connected to one of the two USB Type-C connectors 3, 4. In step S3, the controller 1 verifies whether the first USB device sends out a USB host command to the USB Type-C connector 3 or 4 to which the first USB device is connected. In step S4, the controller 1 sets the USB type-C connector 3 or 4 connected to the first USB device to serve as a host port and the other USB type-C connector 4 or 3 to serve as a device port if the first USB device sends out a host command to the USB Type-C connector 3 or 4 connected thereto in step c). Finally, the controller 1 sets the USB type-C connector 3 or 4 connected to the first USB device to serve as a device port and the other USB type-C connector 4 or 3 to serve as a host port if the first USB device does not send out a host command to the USB Type-C connector 3 or 4 connected thereto in step c). After that, a second USB device can be connected to the USB Type-C connector 3 or 4 which is not connected to the first USB device. As a result, an automatically exchangeable device-to-host interface direction can be obtained.

In sum, by the method of the invention, two USB devices can be randomly connected to any of the two USB Type-C connectors 3, 4. This is very helpful for users.

It will be appreciated by persons skilled in the art that the above embodiment has been described by way of example only and not in any limitative sense, and that various alterations and modifications are possible without departure from the scope of the invention as defined by the appended claims.

What is claim is:

1. A method for automatically exchanging device-to-host interface direction for USB (universal serial bus) type-C connections, comprising:
a) providing a USB interface device with a first USB type-C connector and a second USB type-C connector, wherein the two USB type-C connectors are electrically connected through a switch module;
b) connecting a first USB device to the first USB type-C connector;
c) verifying whether the first USB device sends out a USB host command or not;
d) setting the first USB type-C connector and the second USB type-C connector to serve as a host port and a device port, respectively, if yes in step c); and
e) setting the first USB type-C connector and the second USB type-C connector to serve as a device port and a host port, respectively, if no in step c).

2. The method of claim 1, wherein the USB interface device is a dock.

3. The method of claim 1, further comprising a step f) after step e): connecting a second USB device to the second USB type-C connector.
